(19) United States
(12) Patent Application Publication
(10) Pub. No.: US 2018/0188690 A1
(43) Pub. Date: Jul. 5, 2018

(54) ROLLING HOLOGRAPHIC LITHOGRAPHY

(71) Applicant: METAMATERIAL TECHNOLOGIES USA, INC., Pleasanton, CA (US)

(72) Inventors: Boris Kobrin, Dublin, CA (US); Oliver Seitz, Berkeley, CA (US); Efthymios Kallos, Halifax (CA); Georgios Palikaras, London (GB)

(21) Appl. No.: 15/398,607

(22) Filed: Jan. 4, 2017

(51) Int. Cl. G03H 1/20; G03H 1/04

(52) U.S. Cl. CPC G03H 1/202; G03H 1/0476; G03H 1/0402; G03H 2260/54; G03H 2001/0482; G03H 2223/24; G03H 2001/0441; G03H 2250/42; G03H 2222/34; G03H 2222/53; G03H 2222/36; G03H 2001/0439

(57) ABSTRACT

Holograms are generated using a rotatable transparent cylinder and a coherent light source placed inside or outside of such cylinder to record a hologram in a photosensitive film having a reflective film on one side. Recording is done in continuous mode while cylinder is rotating and photosensitive film is translating underneath in contact with cylinder due to friction forces provided by a layer of sticky polymer.

### FIELD OF THE DISCLOSURE

The present disclosure relates to method and apparatus for recording and copying holograms. More particularly the present disclosure relates to a method of continuously recording holographic fringes on a photosensitive layer.

### BACKGROUND

Holography is an image-recording process distinct from other image-recording processes; both the phase and amplitude of a wavefront that intercept the recording medium are recorded.

Holography can be used to produce apparent three dimensional images when the recording medium is illuminated from the correct angle. Holography can also produce interference or diffraction gratings which can be used to selectively choose different wavelengths of light or create anti-reflective coatings. Holographic gratings are superior to etched gratings in that they reduce the amount light scattering although at the cost of some reflection efficiency.

In the production of holograms in general, an object to be recorded is irradiated with a first component split from a coherent radiation source (e.g. a laser). Irradiation reflected from the object is directed toward a photosensitive medium (e.g., recording media based on photopolymers, hardened dichromated gelatin, or silver halide). A beam of reflected coherent radiation is commonly termed an object beam. At the same time, a second component beam split from the coherent radiation sources is directed to the photosensitive medium, bypassing the object. A beam of such coherent radiation is commonly referred to as the reference beam. The interference pattern resultant from the interaction between the reference beam and the object beam within the photosensitive medium is latently recorded in the photosensitive medium. When the photosensitive medium is processed and subsequently illuminated and observed at the correct angle (i.e., generally an angle correspondent with the incident angle of the reference beam), the irradiation is diffracted by the interference pattern to reconstruct the wave front that originally reached the recording medium as reflected from the object.

In conventional methods of holographic recording a transparent member (e.g. a glass or crystal rod) is brought in contact with the recording medium. The transparent member typically has a refractive index close to that of the recording media in order to reduce the reflection at the point of contact. An index matching fluid is sometimes also used to provide further efficiency in transmission between the transparent member and recording media. Systems like those described in U.S. Pat. No. 5,504,593 issued to inventor Hotta et Al. describe as system including a curved transparent member and use of index matching fluid to reduce friction between the transparent members and the recording media. Additional advances lead to the apparatus described in U.S. Pat. No. 5,576,853 issued to inventor Molteni et Al. which includes the use of a transparent cylinder, index matching fluid and a mirror.

The index matching fluid lubricates the interface between the transparent member and the recording media. A drawback of this is that the index matching fluid also allows for slippage between the recording media and the transparent cylinder. Slippage can create uneven or doubly recorded images in the recording media. Further drawbacks of current holographic methods include the necessity for an independently mounted mirror which is susceptible to vibrations of the apparatus.

It is with these problems in mind that the current invention has been developed.

### BRIEF DESCRIPTION OF DRAWINGS

Each of FIGS. 1 to 5 provides schematic representational illustrations. The relative locations, shapes and sizes of objects have been exaggerated to facilitate discussion and presentation herein.

FIG. 1 is a cross-section front lateral view of illustrating production of holographic fringes in accordance with aspects of the present disclosure in which a cylindrical transparent drum is coated with a sticky polymer and a photosensitive layer and reflective layer arrive as separate sheets to the cylinder.

FIG. 2 shows a lateral slice of the photosensitive layer and reflective layer combination; lines depicting the interaction of radiation with the photosensitive layer are also shown.

FIG. 3 shows a cross-section front lateral view of an alternative in which a reflective layer and the photosensitive film are joined before reaching the cylinder.

FIG. 4 shows a cross-section front lateral view of an alternative implementation in which a photosensitive layer is coated with a sticky polymer.

FIG. 5 shows a cross-section front lateral view of an alternative implementation where the radiation source is located on the outside of the cylinder and the reflective layer coated with sticky polymer faces towards the cylinder.

FIG. 6 illustrates an implementation where a light source is placed off-axis inside a transparent cylinder, and a mirror is placed under a movable photosensitive film to produce “slanted” volume holographic gratings in accordance with an aspect of the present disclosure.

FIG. 7 is a three-dimensional schematic diagram illustrating an implementation that uses a barrel-shaped transparent drum in accordance with aspects of the present disclosure.

FIG. 8 is a side view schematic diagram illustrating an implementation using a transparent drum and a reflecting drum in accordance with aspects of the present disclosure.

FIG. 9 is a side view schematic diagram illustrating an implementation using a transparent drum and a drum with a slanted grating used as a master for a hologram in accordance with aspects of the present disclosure.

FIG. 10 is a side view schematic diagram illustrating an implementation for fabricating a “chirped” grating in accordance with aspects of the present disclosure.

FIG. 11 is a side view schematic diagram illustrating an alternative implementation for fabricating a “chirped” grating in accordance with aspects of the present disclosure.

FIG. 12 is a side view schematic diagram illustrating another alternative implementation for fabricating a “chirped” grating in accordance with aspects of the present disclosure.

### DETAILED DESCRIPTION

In the following detailed description, reference is made to the accompanying drawings, which form a part hereof, and in which is shown by way of illustration specific embodiments in which the invention may be practiced. In this regard, directional terminology, such as “top,” “bottom,” “front,” “back,” “first,” “second,” etc., is used with reference to the orientation of the figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

### INTRODUCTION

Thin films are used commercially in anti-reflection coatings, mirrors, and optical filters. They can be engineered to control the amount of light reflected or transmitted at a surface for a given wavelength. Thin film interference filters (sometimes called dichroic filters or reflection-type Bragg gratings) work on optical principles similar to a Fabry-Pérot etalon. Such filters take advantage of thin film interference to selectively choose which wavelengths of light are allowed to transmit through the device. These films are created through deposition processes in which material is added to a substrate in a controlled manner.

### EXAMPLES

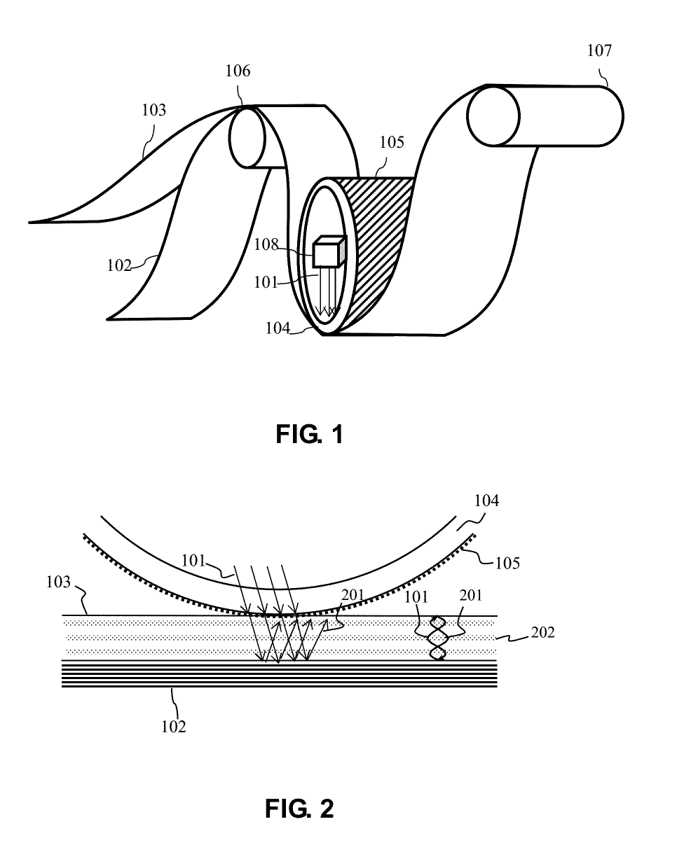

FIG. 1 illustrates continuous holographic production in accordance with aspects of the present disclosure. A photosensitive film (103) is coupled to a reflective film (102), at a loading roller (106) and this combination of film is brought in contact with a transparent hollow drum in the shape of a cylinder (104) coated with a sticky polymer layer (105). Collimated coherent radiation (101) is directed from inside of the cylinder(104) through the transparent hollow cylinder (104) and sticky polymer layer (105) onto the photosensitive film (103) the radiation passes (101) through a contact area between cylinder and a film, passes through the photosensitive film (103) and reflects from the reflective film (102) back in to the photosensitive layer (103), where there is interference between the incoming radiation (101) and the reflected radiation (201). The photosensitive layer (103) reacts to the incoming radiation (101) and reflected radiation (201) in a way that varies the refractive index of the photosensitive layer. The variation in refractive index depends on the local intensity of the radiation in the photonsensitve layer. Such interference modulation of light in the bulk of photosensitive film creates periodic variations in refractive index of photosensitive polymer (202) in a direction perpendicular to the surfaces of the photosensitive layer creating a thin film interference filter. In the illustrated example, the variation, indicated by the shaded regions (sometimes referred to herein as “fringes”), is greatest where the incoming radiation (101) and the reflective radiation (201) constructively interfere; however aspects of the present disclosure are not limited to such implementations. By appropriately selecting the vacuum wavelength of the incident radiation (101), the thickness and refractive index of the photosensitive layer (103) the number and spacing of the resulting fringes in the developed photosensitive layer may be engineered to produce a film that acts as an interference filter that can selectively reflect incident radiation of certain vacuum wavlengths. It is also possible to engineer such an interference filter to include two or distinct sets of fringes at two or more corresponding different spacings so that the filter can reflect two or more corresponding wavelength ranges. This can be accomplished by exposing the photosensitive film to two or more different beams of incident radiation of different vacuum wavelengths, e.g., in separate passes or using a multiple wavelength source of coherent radiation to produce the incident radiation (101).

By way of example, and not by way of limitation, for a filter where the spacing between fringes is d and the refractive index is n and the vacuum wavelength of incident radiation at normal incidence is λ, minimum transmission occurs when 2nd equal to an odd integer multiple of λ/2.

In the implementations depicted herein, the coherent light may be monochromatic (i.e., characterized by a single peak vacuum wavelength) or may be characterized by peaks at two or more different vacuum wavelengths or a broad distribution of vacuum wavelengths. It is noted that monochromatic coherent light is generally characterized by a spectrum having a central peak at a characteristic vacuum wavelength with a narrow distribution of wavelengths about the central peak.

In order to continuously produce holographic images on a sheet of photosensitive material an exemplary system is described without limitation herein; the photosensitive film (103) is loaded onto the loading roller (106) fed underneath the transparent hollow cylinder (104) and on to an offloading roller (107). Likewise the reflective film (102) is loaded underneath the photosensitive film (103) and onto the loading roller (106) fed underneath the transparent hollow cylinder (104) and on to an offloading roller (107). The loading roller (106) and offloading roller (107) are cylindrically shaped and mounted on their longitudinal axis in such a way that they are capable of rotation. The loading roller and offloading roller are positioned with one roller on either side of the transparent cylinder in such a way that a sheet of material fed over top of each of said rollers would come into substantial contact with the transparent cylinder. The transparent cylinder is mounted on its longitudinal axis and is capable of rotation around said axis. The transparent hollow cylinder (104) is coated with a sticky polymer (105). A radiation source (108) is mounted inside the cylinder and is configured to transmit coherent radiation (101) through the transparent hollow cylinder (104) into the photosensitive layer (103). The loading roller (106) and offloading rollers (107) are rotated in synchronized speed with the transparent hollow cylinder (104). The photosensitive layer travels underneath the transparent hollow cylinder (104) as it rotates and the photosensitive layer translates without slipping relative to the cylinder (104) due to friction and stiction forces between a sticky polymer (105) on the cylinder surface and the photosensitive layer (103). By way of example, and not by way of limitation, the sticky polymer (105) may be a cured elastomer, such as cured polydimethylsiloxsane (PDMS).

The web containing the combination of the photosensitive layer and reflective layer is then removed from contact with the sticky polymer on the surface of the cylinder by tension on the web through an offloading roller (107). It should be noted that the sticky polymer increases the friction between the photosensitive layer and the hollow cylinder thereby preventing slippage of the roller or the photosensitive material as it contacts the transparent cylinder. The sticky polymer (105) may also be sufficiently conformable that it makes close contact with both the photosensitive layer (103) and the cylinder (104). The helps avoid an air gap that might lead to undesired reflections due to a large refractive index mismatch between the cylinder and the air gap.

The materials of the photosensitive layer (103), cylinder (104), and sticky polymer (105) may be selected so that they have similar indices of refraction in order to reduce unwanted reflections at the interfaces between the photosensitive layer and the sticky polymer and between the sticky polymer and the cylinder. For the simple case of light travelling from a medium of refractive index n₁ to a medium of refractive index n₂ at normal incidence, the reflection coefficient R is given by:

$$R = {\vert \frac{{n}_{1} - {n}_{2}}{{n}_{1} + {n}_{2}} \vert}^{2}$$

By way of example, and not by way of limitation, the indices n₁, n₂ may be chosen to tune the coefficients of reflection at these interfaces.

FIG. 5 shows another implementation in which a coherent radiation source (508) transmits incident radiation (501) from outside the cylinder towards the photosensitive layer (502), the coherent radiation enters the photosensitive layer and is reflected by the reflected layer (503). The reflective layer (503) is coupled to the photosensitive layer and the combination is mounted with the reflective layer proximal to the cylinder. A sticky polymer (504) is used to enhance adhesion to the cylinder as discussed below. The combination is exposed to the radiation as it traverses underneath the cylinder.

The transparent hollow cylinder (104) may be any material used in the art. Without limitation the transparent hollow cylinder may be made out of borosilicate glass or an optical polymer such as Poly(methyl) Methacrylate (PMMA), depending on the illumination wavelength. In many implementations it is desirable that the cylinder (104) be sufficiently transparent to radiation of the illumination wavelength, e.g., greater than 90% transmission at the illumination wavelength. The length of the cylinder (104) may be about the same as the width of the photosensitive film (103) or larger.

The sticky polymer may be formulated to temporarily adhere the photosensitive layer to the cylinder. Alternatively the sticky polymer may be formulated to temporarily adhere the reflective layer to the cylinder. An example of a sticky polymer fit for the current application is polydimethylsiloxane (PDMS) silicone.

The sticky polymer (105) may be applied to the cylinder (104) by any means known in the art in order to ensure that there is adherence of the photosensitive layer to the cylinder as the photosensitive layer traverses under the cylinder. Examples of techniques for applying polymer to the cylinder (104) include, but are not limited to casting using a mold, e.g., as described in U.S. Patent Application Publication Numbers 20140212536 and 20150365301, which are incorporated herein by reference, by laminating, e.g., as described in U.S. Patent Application Publication Number 20130224636, which is incorporated herein by reference, or by application of liquid polymer precursor onto the surface of the cylinder followed by curing. In some implementations, the sticky polymer may be applied directly (400) to the photosensitive layer before it travels under the cylinder. Alternatively, the sticky polymer may be applied to the reflective before it reaches the cylinder (503).

The coherent radiation may be delivered to the photosensitive layer by any means used in the art. Some examples of suitable means for delivering radiation to the photosensitive layer are; a scanning laser head inside the cylinder or a laser beam transmitting from outside of transparent drum to the inside using a mirror to direct the beam to the photosensitive layer. It would be understood by a person of ordinary skill in the art that the beam of radiation could be of any shape; without limitation suitable examples for the currently described invention may be beam points scanned across the length of the drum or a single collimated sheet of radiation directed toward the photosensitive layer. There may be one or more than one source of coherent radiation. Each source may transmit the same wavelength. Likewise multiple coherent radiation sources may be used at different wavelengths in the present invention to create a film with different optical characteristics at different wavelengths i.e. creating a notch filter for different wavelengths in the same layer. By way of example, and not by way of limitation, the vacuum wavelength of the coherent radiation may range, e.g., from the ultraviolet (starting at about 157 nm) to the infrared (up to about 10 microns).

The reflective film used in the current application may be any type suitable for reflection of the high intensity radiation used in holography. Examples of a material suitable for use as a reflective film would be a polished metal foil such as aluminum foil or a metalized polymer such as Aluminum coated Biaxially oriented Polyethylene Terephthalate (BoPET).

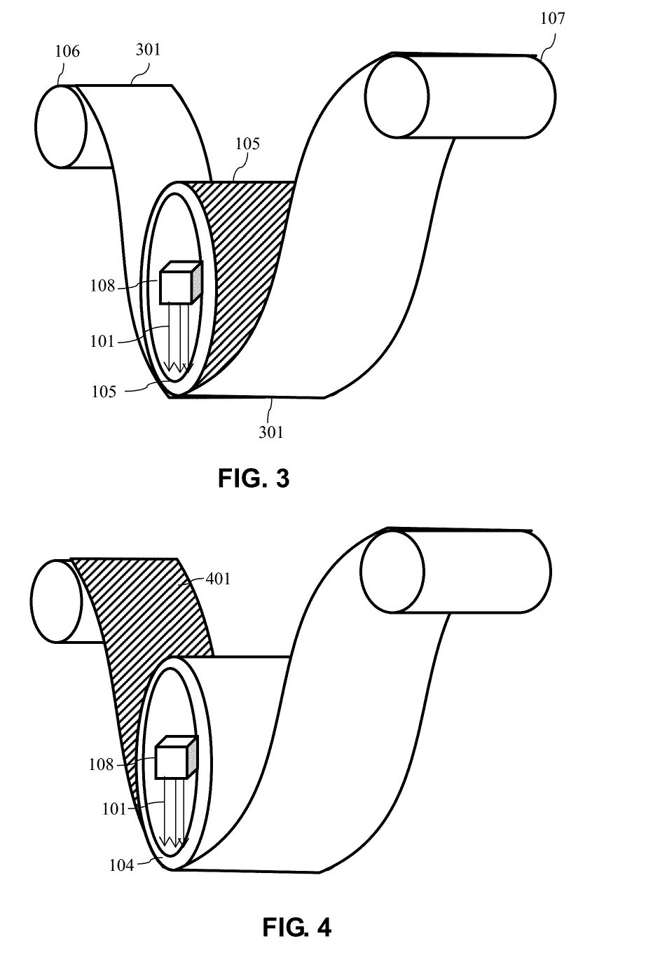

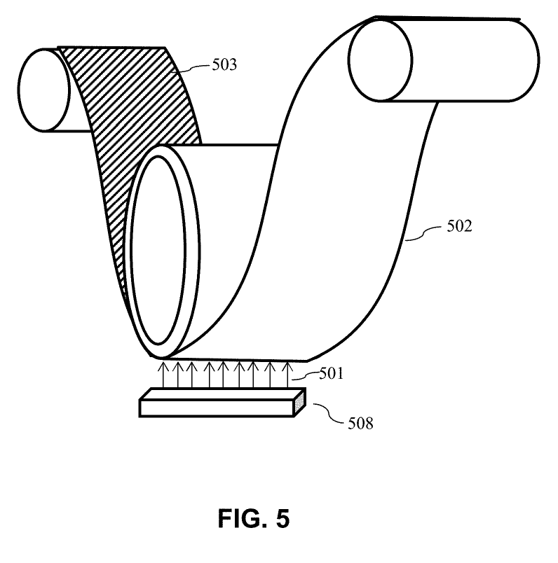

The reflective layer may be coupled with the photosensitive layer by any means used in the art. In one example the reflective layer is rolled underneath the photosensitive layer (106) and the combination travel underneath the cylinder (104) through friction forces. In FIG. 3 the reflective layer may be attached to the photosensitive layer (301). By way of example and not by way of limitation, the reflective layer may be laminated to the surface of the photosensitive layer or adhered to a surface of the photosensitive layer, e.g., using index matched glue or the reflective layer may be a thin metal layer sputter coated onto the photosensitive layer, etc. The reflective layer may be between about 10 nm and about 10 μm thick, depending on film material and deposition method, to reflect the coherent radiation.

In certain implementations the photosensitive film may be between about 1 μm and about 10 μm thick to allow for formation of an interference grating perpendicular to the surface of the layer. The photosensitive layer may be any photosensitive composition known in the art. Some examples of suitable photosensitive material, without limitation are; photopolymers, hardened dichromated gelatin, or silver halide.

A holographic master may be used with the transparent drum. A holographic master contains on its surface or within its material an interference pattern that is desired to be transmitted to another material. Without limitation the holographic master may contain images, designs, grating patterns etc., in the form interference patterns. The holographic master may be etched into the surface of the cylinder, formed inside the transparent drum, or mounted to the outside or inside of the transparent drum in such a way that it rotates with the drum. Alternatively the holographic master may be a film which traverses with the photosensitive layer. The holographic master film may be adhered to the photosensitive layer and the drum through use of the sticky polymer. The holographic master may be used to project holographic images in to the photosensitive layer when illuminated by the coherent radiation.

One practical application for interference filters fabricated in accordance with aspects of the present disclosure as described above is as wavelength-selective reflective coatings for a window to protect against undesired transmission of laser radiation through the window. Windows of vehicles, aircraft and buildings are sometimes subject to unwanted laser radiation from commonly-available laser pointers. Such windows may be coated with a film into which has been formed a dichroic filter or reflection-type Bragg grating, e.g., as discussed above. Variations in the refractive index of the film may be engineered to selectively reflect radiation of one or more vacuum wavelengths emitted by common laser pointers, while transmitting other radiation. Fabricating filters into such films as set forth in the present disclosure allows large area filters to be economically fabricated. In particular, fabrication of optical filters as described herein avoids the need for thin film deposition techniques, which often require a vacuum environment.

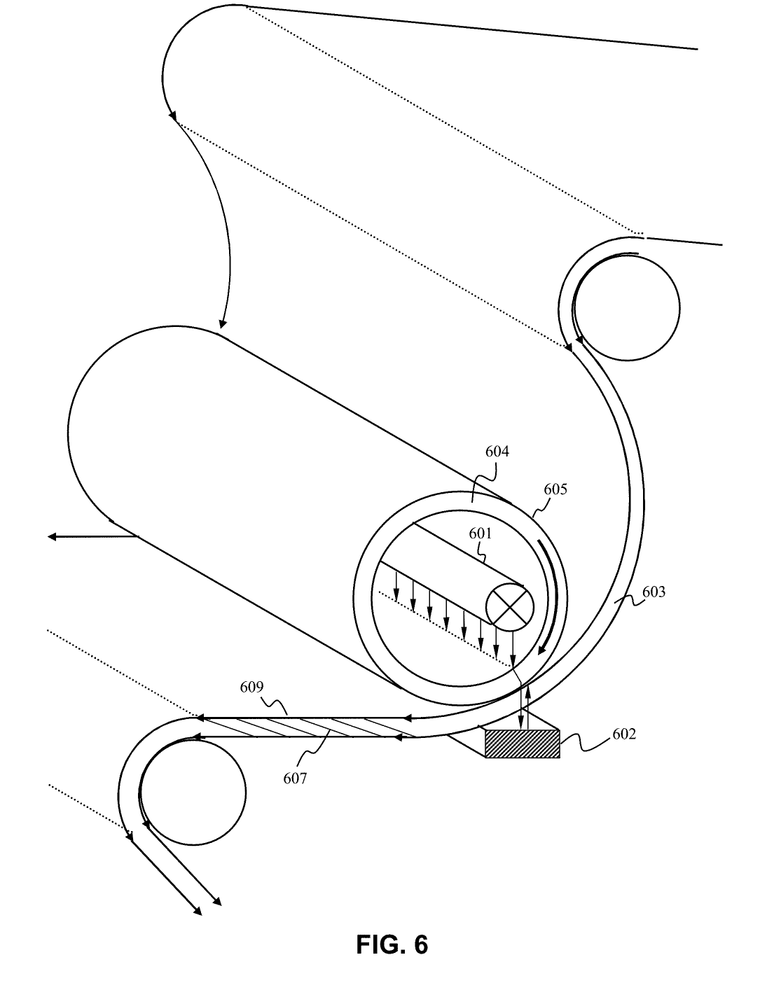

Aspects of the present disclosure include implementations in which the above-described holographic grating fabrication techniques are slightly modified in order to produce “slanted” volume holographic gratings. In such “slanted” gratings, the refractive index in the developed photosensitive film varies periodically in a direction at an angle to the surface normal of the film. FIG. 6 illustrates one possible implementation for manufacturing such slanted gratings. As shown in FIG. 6 a reflective element, such as a mirror (602) may be placed underneath a transparent drum in the shape of a cylinder (604) between the cylinder surface (605) and a photosensitive film 603 moving in contact with a cylinder (604). In some implementations, there may be a sticky polymer (e.g., PDMS) on the outer surface (605) of the cylinder (604) to facilitate slip-free contact between the cylinder and film. A coherent light source (601) is placed off-center (i.e., off-axis of the cylinder) so that the light beam can form sharp angles (<90 degrees) with respect to the surface of the photosensitive film (603) in the area of contact between cylinder and film. The mirror (602) is positioned to reflect light beam back through photosensitive layer. Interference between the incident and reflect light creates a refractive index grating (607) characterized by periodic index variations having a specific angle with respect to the film surface (609).

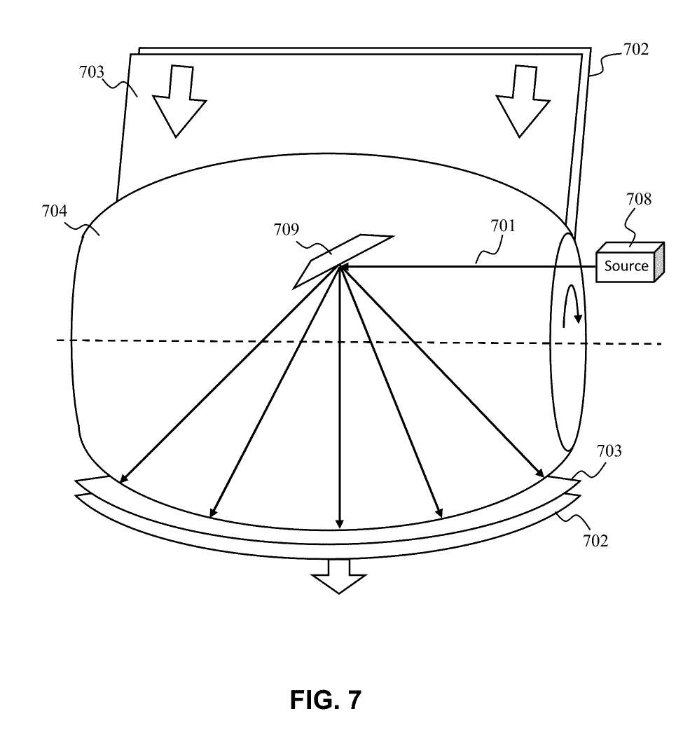

Aspects of the present disclosure include many variations on the implementations discussed above. For example, FIG. 7 depicts an implementation in which the transparent drum is “barrel-shaped” instead of a transparent drum (704), which may be cylindrical. Coherent light (701) from a laser source (708) reflects off a scanning (rastering) mirror (709) located inside the transparent drum. The mirror (703) rasters a beam from the laser source in a direction parallel to the axis of the drum as a photosensitive film (703) backed by a reflective layer (702) pass in contact with the drum. The barrel-shaped curvature of the transparent drum helps to prevent formation a chirp (pitch non-uniformity) of the grating across the width of the photosensitive layer.

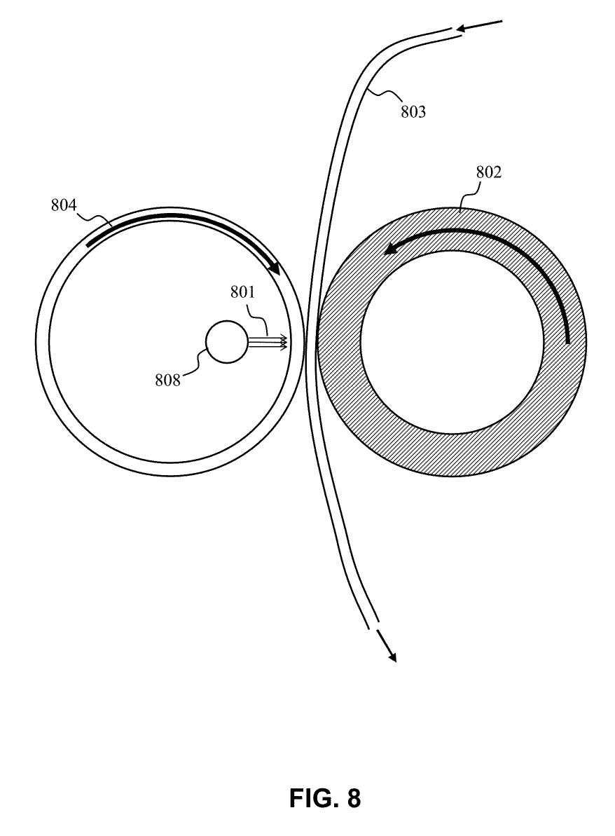

In another implementation illustrated in FIG. 8, it is possible to omit the reflective film and instead use a reflecting mirror formed on a separate rotatable drum (802) that presses a photosensitive film (803) against the transparent drum (804). The mirrored drum (802) reflects radiation (801) from a light source (808) that passes through the transparent drum (804) and the photosensitive film (803).

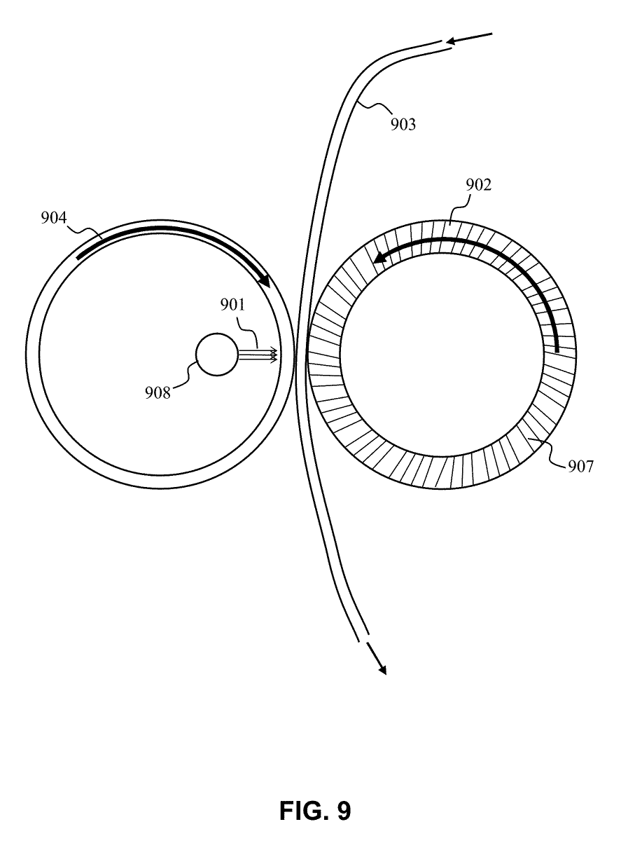

A similar implementation depicted in FIG. 9 may use a slanted grating (907) wrapped around a cylinder (902) instead of the mirror cylinder (802). The slanted grating (907) acts as a master for forming a hologram in a photosensitive film (903) that passes between the cylinder (902) and a transparent drum (904). Coherent light (901) from a source (908) passes through the transparent drum (904), through the photosensitive film (903) and is diffracted back through the film by the slanted grating (907).

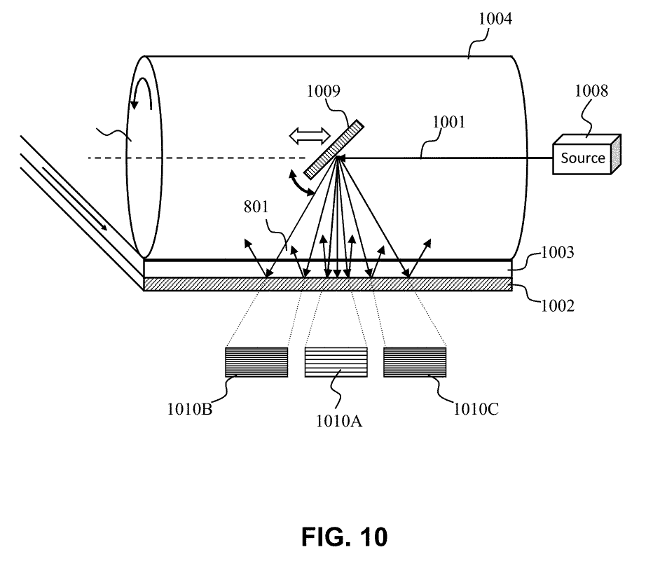

For some applications, a chirped (i.e., variable pitch) grating may be specifically desired. Aspects of the present disclosure include implementations for fabricating such gratings. By way of example, and not by way of limitation, a chirped grating may be fabricated as illustrated in FIG. 10. In this implementation, a photosensitive film (1003) backed by a reflective layer (1002) moves in contact with a transparent cylindrical drum (1004) as the cylinder rotates. A beam of coherent light (1001) from a source (1008) e.g., a laser, is directed into the cylinder along an axis parallel to the axis of the cylinder. The coherent light (1001) reflects from a scanning mirror (1009) that rotates about an axis perpendicular to the cylinder axis to raster the beam over the photosensitive film (1003) as it passes by the cylindrical drum (1004). The scanning mirror also translates back and forth in a direction parallel to the drum axis. The coherent light (1001) passes through the wall of the transparent cylindrical drum (1004) and the photosensitive film (1003) and reflects off the reflective layer (1002) back through the photosensitive film. The coherent light striking the reflective film at different angles forms gratings with varying pitch in the photosensitive film varies. For example, portions of the photosensitive film (1010B, 1010C) where the coherent light passes through and reflects back at an angle have a smaller grating pitch than portions (1010A) where the coherent light passes through and reflects back normal (i.e., perpendicular) to the film.

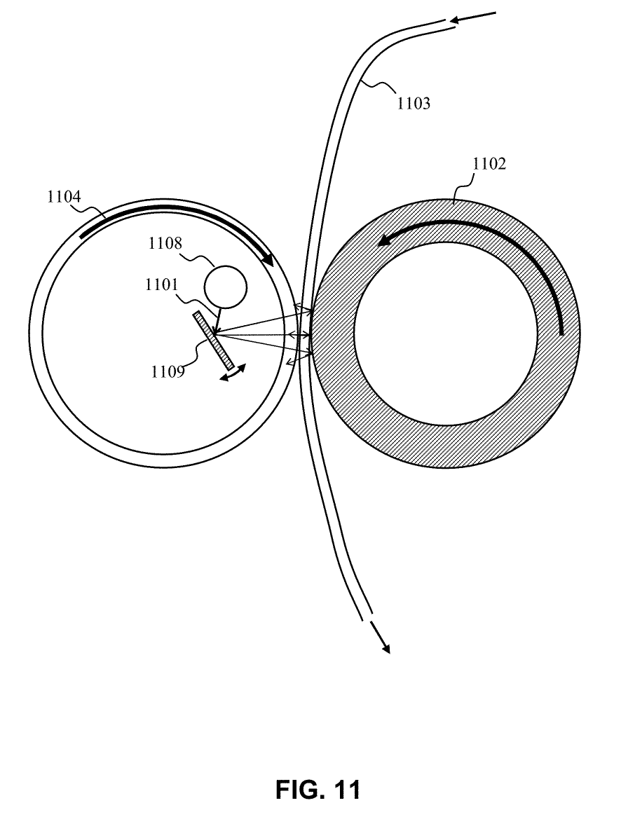

Alternatively, a chirped grating may be created using rastering the beam from light source about an axis parallel to the cylinder axis. By way of example, FIG. 11 illustrates an implementation in which a photosensitive film (1103) passes between a transparent cylindrical drum (1104) and a mirrored drum (1102). Coherent light (1101) from a source (1108), e.g., a laser, inside the drum (1104) reflects from a scanning mirror (1109), passes through the wall of the drum and through the film (1103) and reflects off the mirrored drum (1102) back through the film.. The scanning mirror (1109) rotates about an axis parallel to the axis of the drum (1104) to scan the beam (1101). Coherent light (1101) reflecting off the mirror drum (1102) at different angles forms variable pitch gratings. In this case, the film (1103) moves in a step-and-repeat movement, not a constant roll-to-roll movement. The source (1108) and scanning mirror (1109) may translate back and forth in unison along an axis parallel to the drum axis in each step as the mirror rotates to scan the beam (1101) across the width of the photosensitive film (1103).

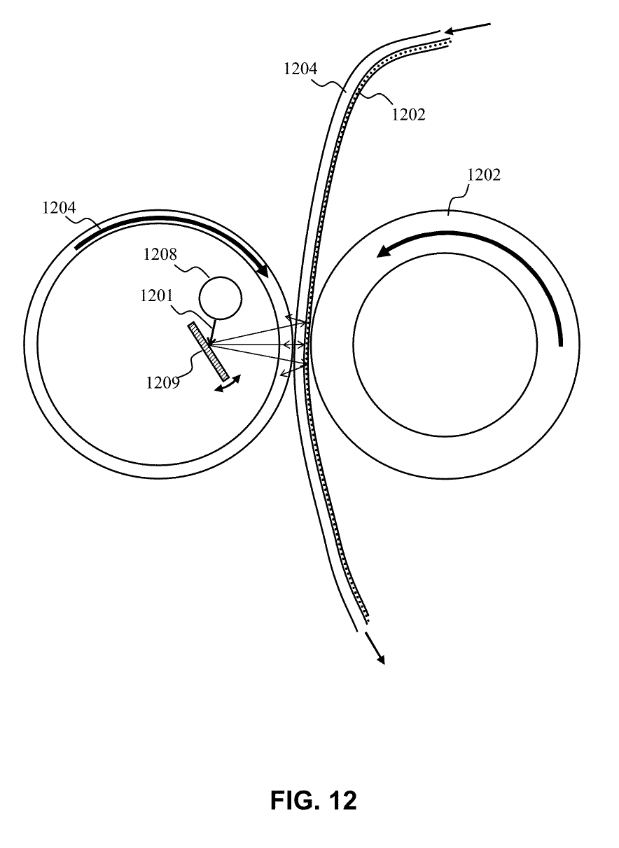

In an alternative to the implementation that shown in FIG. 11, a reflective film may be used instead of the mirrored drum (1102) to make chirped gratings in a photosensitive film. Specifically, as seen in FIG. 12, a web including a photosensitive film (1203) and reflective layer (1202) passes between a transparent drum (1204) and a backing drum (1205). Coherent light (1201) from a source (1208), e.g., a laser, reflects off a scanning mirror (1209) and passes through the wall of the transparent drum (1204) and the photosensitive film (1203) and reflects off the reflective layer (1202) back through the photosensitive film. As in the implementation shown in FIG. 11, the scanning mirror (1209) rotates about an axis parallel to the axis of the transparent drum (1204) to scan the beam (1201). The film (1203) moves in a step-and-repeat movement, as in FIG. 11 and the source (1208) and scanning mirror (1209) may translate back and forth in unison along an axis parallel to the drum axis in each step as the mirror rotates to scan the beam (1201) across the width of the photosensitive film (1203).

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method for recording a hologram, comprising:
a) transmitting coherent radiation from inside a transparent drum through a wall of the transparent drum;
b) while transmitting the coherent radiation, rotating the transparent drum and contacting the transparent drum with a photosensitive layer between the cylinder and a reflective layer; and
c) reflecting the coherent radiation that is transmitted through the transparent drum and the photosensitive layer back through the photo sensitive layer, wherein the photosensitive layer reacts to the coherent radiation transmitted from inside the transparent cylinder and the coherent radiation that is reflected back through the photosensitive layer in a way that varies a refractive index of the photosensitive layer in a direction perpendicular to a surface of the photosensitive layer.

2. The method of claim 1, wherein the transparent drum is coated with a sticky polymer layer.

3. The method of claim 2 wherein the sticky polymer layer includes polydimethylsiloxane.

4. The method of claim 1, wherein a thickness and refractive index of the photosensitive layer a number and spacing of fringes of refractive index variation in the photosensitive layer are configured to act as an interference filter that can selectively reflect incident radiation of one or more selected vacuum wavlengths

5. The method of claim 1, wherein the reflective layer is formed on the photosensitive layer.

6. The method of claim 5, wherein the reflective layer includes a metal film sputter coated onto the photosensitive layer.

7. The method of claim 1, wherein the photosensitive layer is coated with a sticky polymer layer.

8. The method of claim 7, wherein the sticky polymer layer includes polydimethylsiloxane.

9. The method of claim 1, wherein the reflective layer includes a sheet of reflective material coupled to the photosensitive layer.

10. The method of claim 9, wherein the sheet of reflective material is laminated to the photosensitive layer.

11. The method of claim 9, further comprising removing the sheet of reflective material from the photosensitive layer.

12. The method of claim 1 wherein the photosensitive layer rotates with the transparent drum.

13. The method of claim 1 wherein the transparent drum is a holographic master.

14. The method of claim 1 wherein a holographic master is mounted to the outside or inside of the transparent cylinder.

15. The method of claim 1 wherein the coherent radiation is transmitted by multiple sources inside the transparent drum.

16. The method of claim 1 wherein the coherent radiation is in the form of a collimated sheet.

17. The method of claim 1 wherein the coherent radiation is transmitted in a linear scanning pattern across the length of the transparent drum.

18. The method of claim 1 wherein the photosensitive layer is between about 1 μm and about 10μm thick and the reflective layer is between about 10 nm and about 10 μm thick.

19. The method of claim 1 wherein the coherent radiation has a wavelength between 157 nm and about 10 microns.

20. The method of claim 1, wherein the transparent drum is cylindrical in shape.

21. The method of claim 1, wherein transmitting the coherent radiation from inside the transparent drum includes reflecting the coherent radiation with a scanning mirror located inside the transparent drum.

22. The method of claim 21, wherein the scanning mirror rasters a beam in a direction parallel to an axis of the drum.

23. The method of claim 22, wherein the transparent drum is barrel-shaped.

24. The method of claim 21, wherein the scanning mirror rasters a beam of the coherent radiation in a direction perpendicular to an axis of the drum.

25. The method of claim 24, further comprising moving the photosensitive layer relative to the transparent drum in a step and repeat motion.

26. The method of claim 25, wherein the step and repeat motion includes translating the scanning mirror along an axis parallel to an axis of the drum while the scanning mirror rasters the beam of the coherent radiation in the direction perpendicular to the axis of the drum.

27. The method of claim 24, wherein reflecting the coherent radiation that is transmitted through the transparent drum includes reflecting the coherent radiation with a mirrored drum, wherein the photosensitive layer passes between the transparent drum and the mirrored drum.

28. The method of claim 24, wherein reflecting the coherent radiation that is transmitted through the transparent drum includes reflecting the coherent radiation with a reflective layer, wherein the photosensitive layer is between the transparent drum and the reflective layer.

29. A method for recording a hologram, comprising:
a) transmitting coherent radiation from outside a cylinder;
b) while transmitting the coherent radiation, rotating the cylinder and contacting the cylinder with a reflective layer between the cylinder and a photosensitive layer; and
c) reflecting the coherent radiation that is transmitted through the photosensitive layer to the reflective layer back through the photo sensitive layer.

30. The method of claim 24 wherein the cylinder is coated with a sticky polymer layer.

31. The method of claim 25 wherein the sticky polymer layer includes polydimethylsiloxane.

32. The method of claim 24 wherein the reflective layer is coated with a sticky polymer layer.

33. The method of claim 27 wherein the sticky polymer layer includes polydimethylsiloxane.

34. The method of claim 24 wherein the reflective is a sheet of reflective material coupled to the photosensitive layer.

35. The method of claim 24 wherein the reflective layer is laminated to the photosensitive layer.

36. The method of claim 24 wherein the reflective layer is sputter coated to the photosensitive layer.

37. The method of claim 24, wherein reflecting the coherent radiation includes reflecting the coherent radiation with a reflective drum when the photosensitive layer is sandwiched between the transparent drum and the reflective drum.

38. A method for recording a hologram, comprising:
a) transmitting coherent radiation from inside a transparent cylinder through a wall of the transparent cylinder along a direction that is off-axis with respect to an axis of the transparent cylinder;
b) while transmitting the coherent radiation, rotating the cylinder and contacting the cylinder with a photosensitive layer between the cylinder and a reflective element; and
c) reflecting the coherent radiation that is transmitted through the cylinder and the photosensitive layer back through the photo sensitive layer, wherein the photosensitive layer reacts to the coherent radiation transmitted from inside the transparent cylinder and the coherent radiation that is reflected back through the photosensitive layer in a way that varies a refractive index of the photosensitive layer in a direction at a slanted angle with respect to a surface of the photosensitive layer.

39. The method of claim 33, wherein the reflective element is a mirror.

40. The method of claim 33 wherein the transparent cylinder is coated with a sticky polymer layer.

41. The method of claim 35wherein the sticky polymer layer includes polydimethylsiloxane.

42. The method of claim 33, wherein reflecting the coherent radiation includes reflecting the coherent radiation with a drum-shaped slanted grating, when the photosensitive layer is sandwiched between the transparent drum and the drum-shaped slanted grating.
